(19) United States
(12) Patent Application Publication
(10) Pub. No.: US 2015/0186600 A1
(43) Pub. Date: Jul. 2, 2015

(54) Secured Emergency Medical History Display

(71) Applicant: William Diaz, Kissimmee, FL (US)

(72) Inventor: William Diaz, Kissimmee, FL (US)

(21) Appl. No.: 14/207,897

(22) Filed: Mar. 13, 2014

Related U.S. Application Data
(60) Provisional application No. 61/921,483, filed on Dec. 29, 2013.
(60) Provisional application No. 61/927,093, filed on Jan. 14, 2014.
(60) Provisional application No. 61/944,211, filed on Feb. 25, 2014.

(51) Int. Cl. G06F 19/00; G06F 3/041

(52) U.S. Cl. CPC G06F 19/322; G06F 3/0412

(57) ABSTRACT

An emergency medical history display that can display a patient's medical history in a view only mode when a special micro sized SD card containing the patient's medical history is inserted into a port of the display. The display has no memory to store the medical history and thus the medical history is erased from the display when the display is turned off or the SD card is removed from the display. The display is secured in that it is sealed to prevent access to the inside. A special micro SD card with software on both the display and the SD card will allow for the medical history to be viewed only on these special displays.

### CROSS-REFERENCE TO RELATED APPLICATIONS

This application claims the benefit to U.S. Provisional Application 61/921,483 filed on Dec. 29, 2013 and entitled EMERGENCY MEDICAL DEVICE; and to U.S. Provisional Application 61/927,093 filed on Jan. 14, 2014 and entitled SECURED EMERGENCY MEDICAL HISTORY DISPLAY; and to U.S. Provisional Application 61/944,211 filed on Feb. 25, 2014 and entitled SECURED EMERGENCY MEDICAL HISTORY DISPLAY.

### GOVERNMENT LICENSE RIGHTS

None.

### BACKGROUND OF THE INVENTION

1. Field of the Invention

The present invention relates generally to a secure display that can display a patient's medical history to an authorized medical service provider in a secure way.

2. Description of the Related Art Including Information Disclosed Under 37 CFR 1.97 and 1.98

A medical device is carried by a person that provides emergency personal with critical patient information in the need arises for emergency medical treatment in the event that person is not able to communicate any medical history that could affect medical treatment. Other medical information about the specific patient can be included on the wrist watch or pendant that would provide emergency medical personal with updated information to treat the person.

One major drawback with a medical bracelet worn around a wrist by a person is that the limited information medical bracelet is easily seen by others, which could be an embarrassing moment for certain people such as the elderly and especially for those people applying for employment. Some worn medical emergency bracelets can even be read by others and thus a person's medical condition could be found out by another without the person's consent.

During an emergency many people are taken to a hospital emergency ward unconscious or semi-conscious and are unable to provide their correct medical history and their emergency contact information. Patients with serious medical conditions are exposed to be incorrectly diagnosed and exposure to the possibility that certain drugs used might endanger the patient life. Being able to review the patient's history within seconds of his arrival is critical and is a lifesaving procedure which can be used at any hospital nationwide and possibility worldwide. A patient's medical history is very confidential and according to HIPPA (Health Insurance Portability and Accountability Act) must be kept secure.

Medical bracelets are known in which a patient wears one that indicates certain medical conditions that patient has, such as diabetes so that an emergency medical provider would know of a precondition that would affect treatment. However, these medical bracelets are visible and easily recognizable by others around the patient and thus can be an embarrassment to the patient if others know of these medical preconditions. Also, these medical bracelets do not contain any a complete, updated history of the patient's medical conditions.

### BRIEF SUMMARY OF THE INVENTION

In a hospital, emergency cases arrive every day with incoherent or unconscious patients, with little or no information on their medical history. This device would allow the emergency room attendants or ER doctors to download the patient's medical history and proceed with the corrective medical procedure within seconds and notify all necessary contacts.

A medical information emergency device which is comprised of a portable encrypted micro SD card attached to the back of a watch or pendant. The device provides complete medical history and emergency contact information including a standard emergency room form, personal information, emergency contact, primary care physician, medication, insurance coverage, food and drug allergies, medical history, previous surgical procedures, special needs and other health issue information.

A sealed emergency medical history display or monitor includes a secure stand-alone view only display (or monitor) with one USB port and the ability to scroll letter size documents as well as a view of a facial picture of the patient for confirmation of identification. No retention of the patient's medical history is saved on the display once the patient's micro SD card is removed.

The encrypted micro SD card would sit beneath a water proof 1″ inch diameter plastic cover with an EMS (emergency medical symbol) emblem which is then attached to the backside of a watch, bracelet or pendant or any other wearable device, allowing the micro SD card to be identified, removed and inserted into a micro USB adapter which is then inserted into the USB port of a secure stand-alone view only monitor. Once the micro SD card is removed from the secured monitor, all information is removed from the monitor. No information is stored in the monitor. After the micro SD card is read and the critical information is acquired, a new water proof cover is placed over the micro SD card and reattached to the watch, pendant or other personal devise of the patient. The end user would be responsible for updating his or her personal information and emergency contacts. The primary physician would be responsible for updating the medical history of the patient. All health care givers and emergency providers would have access to the device to update the patient medical history with the patient's authorization pass word on their laptop or desktop. Only the ER hospital's secure stand-alone monitor (EMHD) and the emergency response team display would have a generic pass word access to any patient's medical history through classified assignment.

It is understood there are other emergency bracelets, necklaces and information devices available but none of these devices provide the amount of secure encrypted personal identification and information required during an emergency situation in a fast, secure, consistently updated, convenient and practical format while also complying with HIPAA (Health Insurance Portability Act), the federal law that protects personal medical information and recognizes the rights to relevant medical information involved in providing medical care.

It is the policy of all hospitals to restrict the use of an outside USB drive to be utilized with any of their monitors or computers for fear of introducing a virus into their system and the possibility of having their patient's medical history downloaded as well as the chance of corrupting the hospital's secured network.

The chance of a virus accessing or corrupting a patient's medical history is the reason why a secure stand-alone medical history monitor is required. It is designed to meet HIPAA Federal law for the security of electronic protected health information being used to analyze patient's emergency events.

This system would allow patient's medical history to be shared with emergency medical providers within seconds. The information is encrypted into the Micro SD card by the patient and the medical providers and will ensure that during any medical emergency, the possibility of major treatment errors or misdiagnosed procedure will be avoided.

A stand-alone emergency medical history monitor, when compared to the proposed National Medical History Data Bank, would prevent millions of patient's medical histories to be shared and exposed by a virus, thus violating the patient's privacy rule. This emergency medical device is low cost, secure and falls under the concept of need to know basis, only active in an emergency situation or the transfer of information by the patient or his medical provider.

### BRIEF DESCRIPTION OF THE SEVERAL VIEWS OF THE DRAWINGS

FIG. 1 shows a wrist watch with an emergency medical symbol emblem which can be used to carry the hidden SD card with the medical history of the present invention.

FIG. 2 shows a micro SD card and a micro SD card adapter of the present invention.

FIG. 3 shows a set of car keys with a micro SD card in an adapter of the present invention.

FIG. 4 shows an isometric view of the emergency medical history display (EMHD) of the present invention.

FIG. 5 shows a front view of the emergency medical history display of the present invention.

FIG. 6 shows a back view of the emergency medical history display of the present invention.

FIG. 7 shows a side view of the emergency medical history display of the present invention.

### DETAILED DESCRIPTION OF THE INVENTION

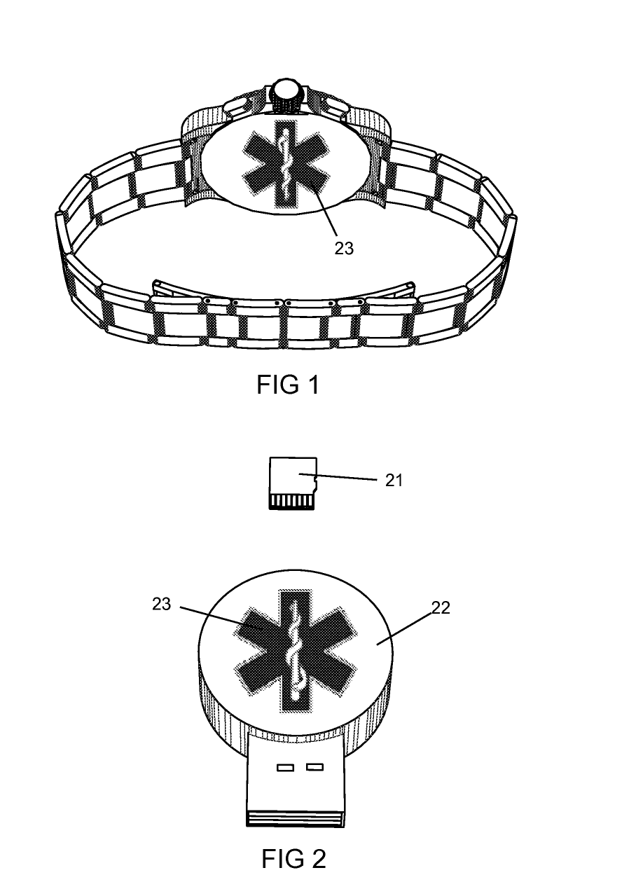

The present invention is a medical information emergency device comprising of a portable encrypted micro SD card, which is attached to the back of a wrist watch, pendant or other devise and would provide a complete or incomplete medical history and contact information that would include information such as a pre-filled standard emergency room form, containing personal information, emergency contact, primary care physician, medication, insurance coverage, food and drug allergies, medical history, previous surgical, special needs, consent status form and health issues information. The medical information emergency device would thus be hidden behind the wrist watch so that others cannot see that the person is carrying a medical emergency device. The device could also be part of a key chain. The device would contain an EMS (emergency medical system) emblem identifying that device as containing a micro SD card with the patient's medical history and other information. FIG. 1 shows a wrist watch in which a micro SD card is contained on a back side in a sealed way that contains the person's medical history, and an emergency medical symbol emblem over the SD card indicated to an emergency medical provider that the watch contains an SD card with the person's medical history.

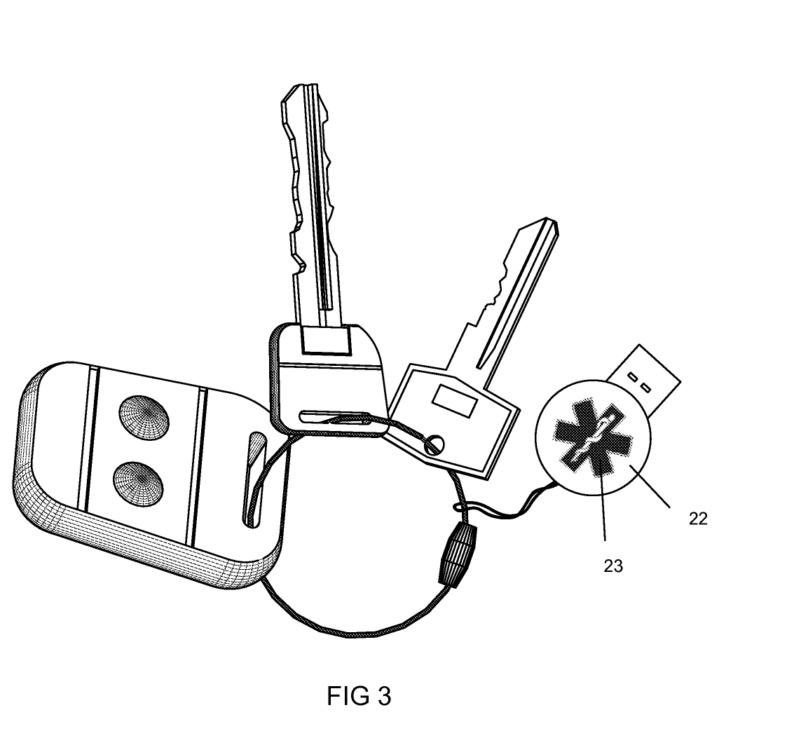

The micro SD card would sit beneath a water proof cover with the EMS emblem attached to the back portion of the watch which would allow the micro SD card to be removed and inserted into a USB drive adapter and then reinserted to any pc laptop or desktop or secure EMHD or monitor (herein referred to as a display or a monitor). The end user would be responsible to update his personal information and the primary physician would be responsible for updating the medical history of the patient. All health care givers would have access to SD card to view and update the patient medical history with the patient's authorization code. Only hospital emergency departments and emergency response teams would have a generic code access to any patient's medical history through classified assignment. FIG. 2 shows a micro SD card 21 which would contain the medical history and other information for the person wearing a device such as a wrist watch, and a micro SD card adapter 22 with an emergency medical system emblem 23 on display indicating that the adapter is used to insert the SD card 21 into an EMHD 10 to view the medical history. FIG. 3 shows the SD card adapter 22 connected to a car key chain.

In a hospital, emergency cases arrive every day with critically injured or sick unconscious patients, often elderly, with little or no information on their medical history. This devise with the micro SD card would allow the emergency room attendants to download the information and proceed with the corrective medical procedure within seconds and notify all necessary contacts.

It is understood that there are other emergency bracelets, necklaces and other information which the patient could carry but none of these devices provide the amount of information required during an emergency situation that is so secure, convenient and practical. This low cost device would allow constant updated information to be provided by the health givers for accurate diagnosis during any medical emergency and would prevent any major errors.

The present invention is also a secure emergency medical history display (EMHD) or monitor used by authorized medical personal to display a complete medical history of a specific patient in order to best treat that patient during a medical emergency in the shortest period of time.

The EMHD is a monitor which is used as a document reader in conjunction with a secure micro SD card that can display black and white (or color) images of a patient's identification and other information along with a complete medical history. The EMHD can be secured to a wall of a room or a desk so that it cannot be removed. Also, the EMHD can be used as a portable unit with a battery for first responders, but in a hospital would use a power cable and not a battery for power so that it cannot be removed and used outside of the authorized area.

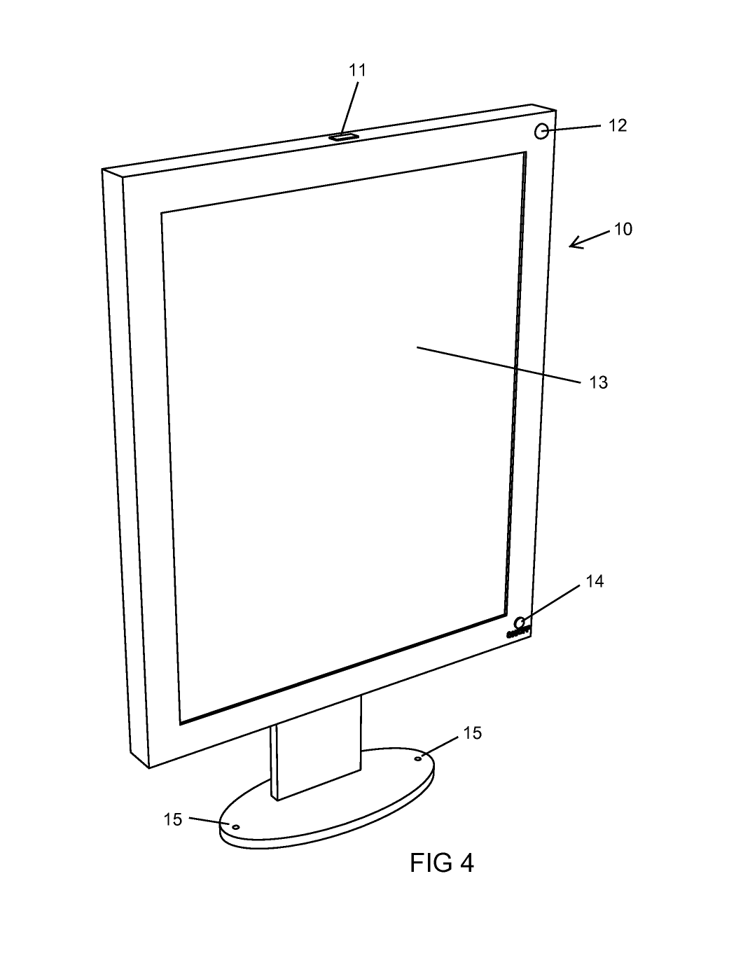

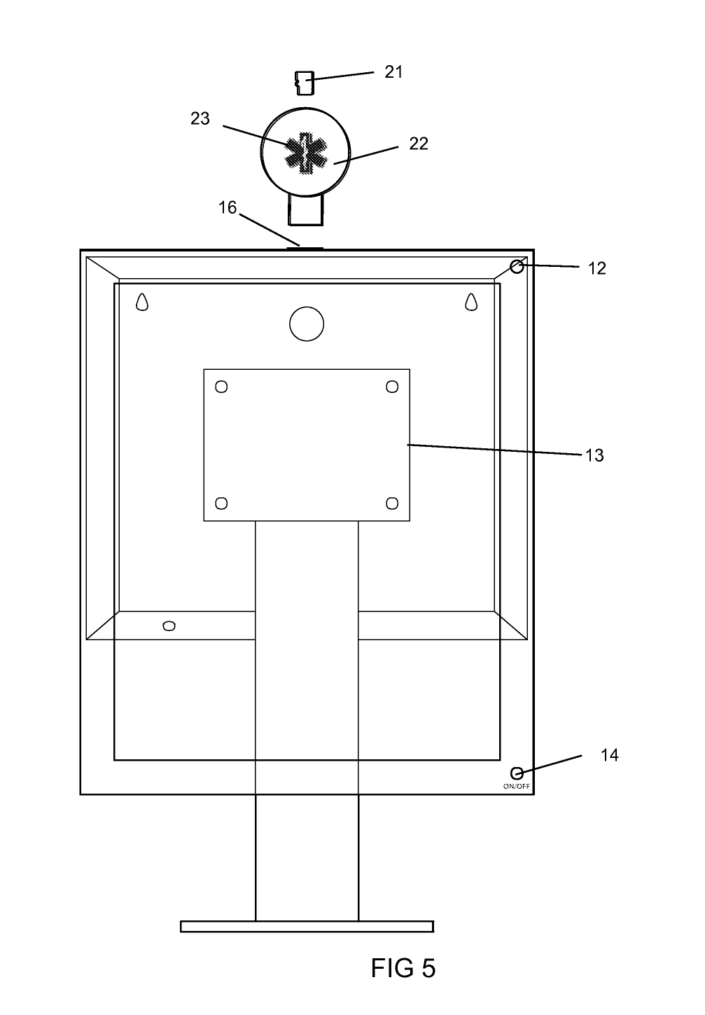

FIG. 4 shows an isometric view of the EMHD of the present invention. The EMHD 10 includes a single USB port 11 with an SD micro adapter card 22 which allows the insertion of a micro SD card 21 containing a patient's medical history and identification and other information. A micro SD card is preferred because it is smaller than the regular SD card so that the card can be easily hidden in a wearable device such as a bracelet or a wrist watch. The micro SD card 21 will contain all the necessary medical history of a patient along with a picture of the patient and other information such as name and address of the patient, emergency contact information, and name of primary care physician or other doctors that treat the patient. The information contained in the micro SD card 21 such as the picture ID is used to identify the patient with the proper SD card so that the SD card and medical history matches with the patient. The micro SD 21 card contains software that will not allow for the contents to be read unless the SD card is inserted into a secure EMHD unit and a pass word is entered. The EMHD 10 and the micro SD card 21 both contain software that will only allow the contents on the SD card to be viewed by the EMHD 10 if a special pass code for the hospital is entered on the touch screen of the monitor 10. Inserting the micro SD card 21 into an unsecured PC will not allow for the content of the SD card 21 to be read unless the patient's personal password is entered. For purposes of the description of the present invention, a password is what a patient or authorized user would enter into a computer in order to read and write to the micro SD card. The pass code is the code that an authorized user would enter on the touch screen of the monitor in order to view the medical history of an SD card inserted into the monitor.

The EMHD 10 contains software that will identify a medical history SD card and display the information. Each EMHD 10 display will be able to read the information on the micro SD card 21. For example, one hospital might use several EMHDs located in various rooms in which each EMHD will require the hospital's assigned generic pass code for access to patient medical history only during an emergency situation. When a patient arrives to the hospital, the micro SD card is removed and inserted into the micro SD adapter 22 connected to the USB port 16 in the EMHD 10 and the authorized user enters the pass code. The EMHD 10 will then display the medical history of that patient from the micro SD card 21. The EMHD 10 and the micro SD card 21 both contain software that will allow the EMHD 10 and the SD card 21 to exchange data so that the contents of the SD card can only be viewed by the special EMHD 10.

The EMHD 10 can be turned on and off 14 by pushing the on/off button. The EMHD 10 has no memory inside and only reads the medical history from the micro SD card when the card is inserted into the USB port 11. When the EMHD 10 is turned off or when the micro SD card is removed, all data is erased from the monitor 10 and is no longer viewable.

The EMHD 10 is secured to a wall or desk of the room so that it cannot be removed. Also, in a hospital facility the EMHD is powered not by a battery or with a battery backup but only with a power cord that is plugged into a power outlet in the room. This way, the EMHD 10 cannot be removed or stolen and then used to obtain the medical history in an unauthorized way.

The EMHD 10 will not store information from the micro SD card 21 but only display the information when the micro SD card is inserted into the micro card adapter 22 connected to the USB port 16 of the monitor. When the micro SD card is removed from the EMHD 10, all data is removed from the EMHD so that it cannot be copied. The EMHD 10 also allows a ring key micro SD card adapter with an SD card to be inserted. The ring key is a USB micro SD card adapter with the patient's micro SD card which can be used as a 2^{nd} backup for the patient's primary micro SD card and also contains the patient's medical history and information required for treatment when the micro SD card is not working or cannot be located. The EMHD 10 has only one input port and that is a USB port 16. This prevents the information from the SD card from being copied over to a SD card slot a 2^{nd} USB port. The micro SD adapter key ring is a backup for the primary micro SD card which sits under the patients watch or behind a pendant. The micro adapter key ring can also have an emergency medical symbol 23 on one side on the surface that identify the adapter key ring as an emergency medical history device and on the other side other information about the patient such as the medical community the patient might belong to. For example, the patient might be a member of a medical community or a retirement community that is also displayed on the key ring adapter.

The micro SD card can also be programmed to display only certain information on the patient's medical history to certain levels of authorized personnel. For example, a doctor would have access to the complete medical history while a nurse could have access to limited information that is required with the service that the nurse is authorized to provide to the patient. An EMT (Emergency Medical Technician) would also only be authorized to access or view limited information about the patient's medical history.

The micro SD card 21 can contain encrypted software that will allow certain authorized personnel to enter a password and update their information on the medical history. For example, the patient would have access to update his personnel information such as address, phone number, emergency contact information, or photo ID. A primary care physician would only be able to update the micro SD card medical history with his information concerning the patient. A specialist such as a cardiologist would only be able to update his information for the patient. The hospital would only be able to update the hospitals information on the patient's medical history. Neither one can update another's medical information on the patient's micro SD card. However, all can view each other's information.

The micro SD card is covered completely within a waterproof material such as a 3M Protective tape with an emergency medical symbol (EMS) 23 on the outside secured to a device such as a wrist watch, a pendant, bracelet or other device worn or carried by the patient. An emergency medical provider would know that a medical history device is worn or carried by the patient by the emergency emblem EMS 23 and remove the micro SD card from the waterproof protective tape to insert into the monitor. When the micro SD card is returned to the patient, the micro SD card is covered with a new waterproof protective tape to prevent water damage to the card. The adhesive tape will also secure the micro SD card to the wearable device carried by the patient.

FIG. 4 shows an isometric view of the EMHD or monitor 10 with a stand that rests on a flat surface such as a desk or table. The EMHD or monitor 10 can also be attached to a wall. FIG. 5 shows a front view of the EMHD. In one embodiment, the EMHD 10 includes a touch screen 13 with a 15 inch screen. This size will display an 8½ by 11 inch document in full size. The EMHD 10 includes an on/off switch 14, screen with touch screen technology to allow scrolling through pages of the medical history, an SD card activated indicator light 12, a USB port 16, a function button and a touch screen keyboard to allow the pass word to be entered. Each EMHD 10 is sealed at a factory prior to deliver to a customer such as a hospital in which a special pass code for that customer has been entered into the software. Thus, when the monitors 10 arrive at the customer such as a hospital, the pass code is already in the monitor 10 so that authorized personal of the hospital can view any patient's medical history on the micro SD cards 21 by entering the special pass code on the touch screen monitor 10. The monitor 10 is sealed so that access to the inside is prevented. Someone would have to break open the plastic case in order to get at the inside electronics.

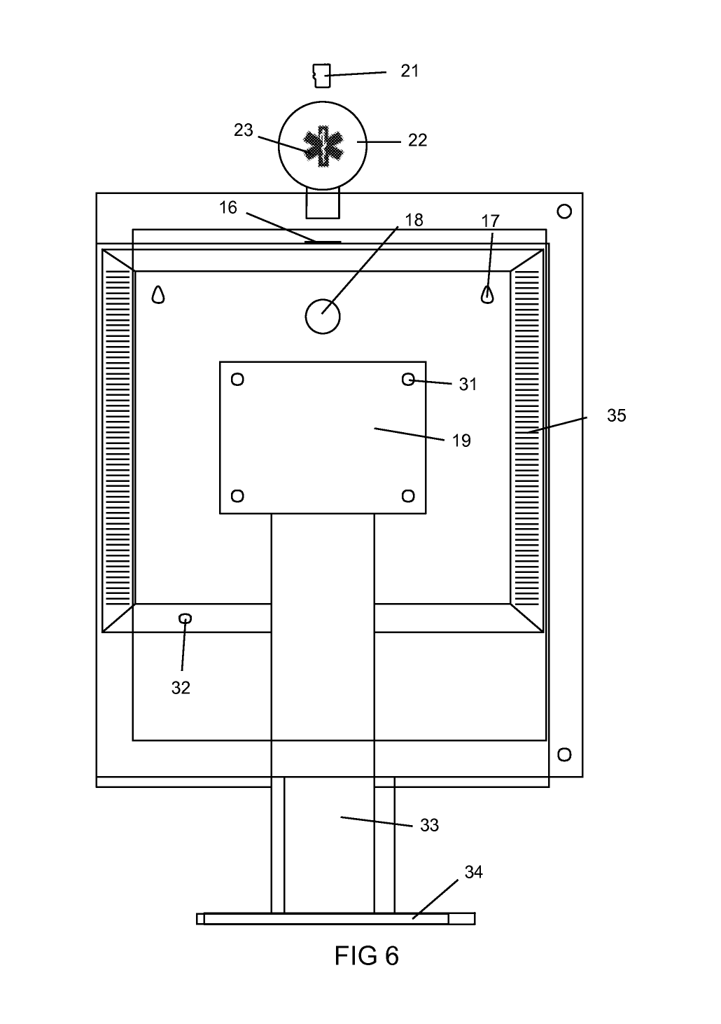

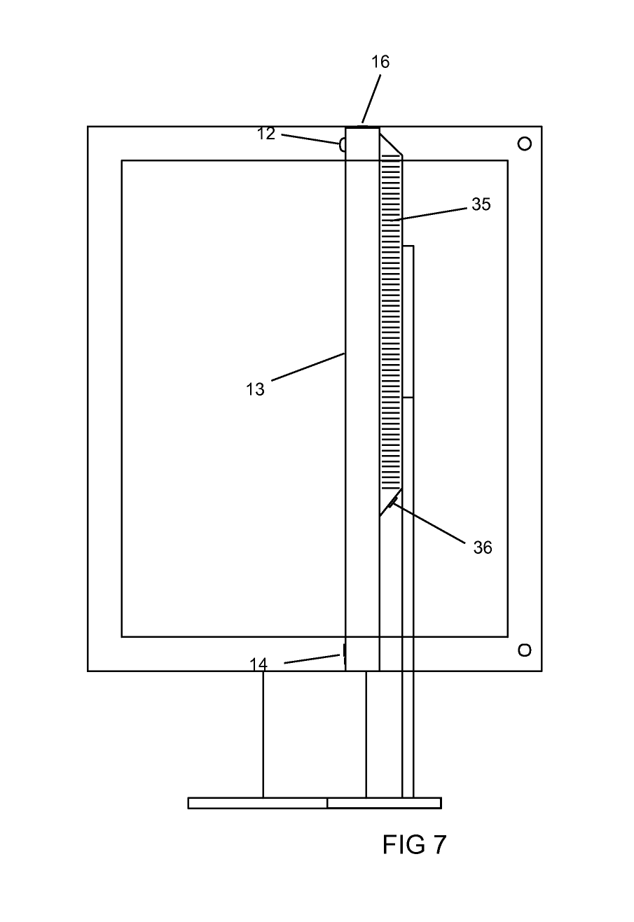

FIG. 6 shows a back view of the monitor with ventilation slots 35. The back side of the monitor 10 includes two wall mounting holes 17, a piezo alarm buzzer 18, a stand mounting bracket 19 with four screw holes 31, a D/C input from a power adapter 32, a stand 33 and a stand mount 34 with screw holes to secure the monitor 10 to a table or other fixture. FIG. 7 shows a side view of the monitor 10.

A micro SD card is used in order to more easily store the card on a patient's body because of its smaller size and the ability to hold large amount of information. The micro SD card is removed from the patient's wristwatch, pendant or bracelet and inserted into a micro SD adapter 22 which is then reinserted into the USB port 16 of the monitor 10. The amber light 12 on the upper right hand side will display if the USB port 16 is activated and will stay lit until the SD card 21 (contained within the adapter 22) is removed. A piezo alarm will sound after a preset time if the card is not removed. This is to secure the patient's SD card.

Once the patient micro SD card is activated, a directory will pop up requesting a pass code. Once the pass code is entered, the following information on separate pages can be scrolled: a photo image of patient, for identification confirmation, a page of patient's personal information which includes emergency and primary doctor contacts, a page for the emergency medical care service providers (ambulance), a page for the primary physician contact information with his summary of patients medical history, additional summary pages for other health care givers (cardiologist, neurologist, etc.), and recent hospital records.

To prevent unauthorized access and other compromises, the monitor 10 is thermally sealed and without screws to secure it together. A special pass code for each customer will be created in the sealed monitor 10 prior to shipment to that customer. An unauthorized person thus could not gain access to the patient's medical information for example by inserting a storage device inside the EMHD.

One use for the EMHD (monitor) 10 is described below. A patient will wear a micro SD card 21 with medical history on a device such as a wrist watch in which the micro SD card is secured within a waterproof protective tape. When the patient must be treated, the waterproof protective adhesive tape is removed and the micro SD card 21 inserted into the monitor 10 using the micro card adapter 22. The monitor will recognize the SD card and require the pass code of the hospital to be entered. An authorized medical person will then enter the pass code and the patient's information is displayed on the monitor 10 according to the access level. The monitor will first display the patient's information such as name or photo ID so that the emergency medical person can verify that the patient is the person on the SD card. The monitor will then display the patient's medical information so that the correct treatment can be provided. When the patient's information is read and the treatment is completed, the SD card is removed from the monitor and resealed in a waterproof adhesive tape and placed back onto the patient's watch or pendant. When the SD card is removed from the monitor 10, all information is erased from the monitor 10 so that the information cannot be copied. The monitor 10 does not have the capability to store a patient's information once the micro SD card is removed from the monitor 10.

The micro SD card can only be updated when it is inserted into a computer or other device that has the patient's password to read and update the SD card. For example, a notebook or laptop computer can be used with the authorized password that will allow the medical history of the patient to be viewed and updated. The treating person can then update the information on the patient's micro SD card. To update the patient's information (such as picture ID or emergency contact), the patient's doctor's office or other authorized person can insert the SD card into a computer with the required pass word and update the information.

In another embodiment, each monitor is set up so that each authorized user would have an individual pass code to access the SD card and medical history and that access code is recorded in the SD card. This would be required for limiting certain information on the medical history to certain persons. For example, a doctor would be granted access to the full medical history. An EMT would be granted limited access to that which is required for treatment provided.

In one embodiment of the micro SD card and the EMHD 10, a patient's complete medical history can be stored in an encrypted format with a password or without encryption and using no password. This would be up to the individual patient. If the micro SD card is encrypted, then a pass code would be required to view the SD card using the monitor 10. Each hospital would have a number of the EMHDs 10 and each would require a special pass code issued by the hospital for anyone to view the medical history on the SD card. Authorized personal of the hospital would thus have the pass code that he or she must enter before the monitor 10 will display the patient's medical history. Instead of a pass code issued by each hospital, authorized personal typically would have a special ID that has a bar code or wireless signal indicating the person is authorized for access. The monitor 10 could have a special reader that can read a persona's ID card to determine if that person is authorized to view contents of the micro SD card.

It is the policy of all hospitals to not permit any USB drive to be inserted into any of their monitors or computers for fear of introducing a virus into their system and the possibility of having their patient's medical history downloaded as well as the chance of corrupting the hospital's secured network.

The chance of a virus accessing or corrupting a patient's medical history is the reason why a secure stand-alone medical history monitor is required. It is designed to meet HIPAA National Standards for the security of electronic protected health information being used to analyze patient's emergency events.

This system would allow patient's medical history to be shared with emergency medical providers within seconds. The information is encrypted into the Micro SD card by the patient and the medical providers and will guarantee that during any medical emergency, the possibility of major treatment errors or misdiagnosed procedure will be avoided.

A stand-alone secure medical monitor, when compared to a National Medical Database, would prevent millions of patient's medical histories to be exposed by a virus, thus violating patient's privacy rule. This emergency medical device is fast and secure, falls under the concept of a need to know basis and is only active in an emergency situation. It also allows reasonable, secure access to medical history, transfer of medical history or updating information.

In another embodiment of the present invention, a doctor's office can replace a hard drive that or paper files that stores all of the patient's medical records onto individual SD cards which can be read by a secure monitor or a computer with the authorized software capable of reading from and writing to the SD cards. As an example, a doctor might have 100 patients that he sees on a regular basis. Each one of the 100 patients might have a separate folder in a file cabinet at the doctor's office or stored on a common hard disk on a computer system. The hard disk would need to be backed up on a regular basis in the case of a disk crash. If a hacker gains access to the hard disk, then all of the 100 patient's files would be compromised.

In the present invention, each patient will have his/her entire medical history stored on one SD card so that the doctor's office will have 100 SD cards in a secure location or vault with the medical records for each of the 100 patients. All of the 100 SD cards could also have a backup SD card so that the doctor's office would have 200 SD cards or two SD cards for each of the patients in a secured location. When one person's medical records are to be viewed or changed, both SD cards for that patient would be retrieved from the secure location and inserted into the secure medical history monitor. Both SD cards are inserted into a micro SD duplicator in order to read from or write to the SD card. If one fails, then the other readable SD card can be accessed and a new SD card inserted to replace the damaged SD card and the medical history transferred over to the new SD card. If one SD card fails, the office would not know of the failure until the time to view the SD card. Thus, using two SD cards will add security if and when one of the SD cards fails without losing all of the data on the failed card. The chances of both SD cards failing together are remote. Thus, the use of two SD cards for each patient for at a doctor's office will prevent all of the patient's medical records from being compromised at the same time. Plus, the use of two SD cards for each patient will prevent the loss of the patient's medical history if one of the SD cards fails. An SD card duplicator allows a laptop or desk top to update both cards at the same time. The idea of doctors using SD cards as storage of patient's medical history is to eliminate hundreds of paper files and to prevent a hacker from downloading a virus and gaining entry into their network and exposing their patient's medical history. A recent case occurred in Miami, Fla. in which a doctor's network was blocked and held for ransom. This same technology can be used in different industry to eliminate paper files.

In the embodiment where the micro SD card is encrypted, the hospital's EMHD monitor 10 will have the capability to view the patient's medical history when a pass code is entered to the display or using an ID card issued by the hospital that is scanned by the monitor if the monitor has the bar code reader or an added attachment that can read an ID card. In order to update the medical history on the encrypted SD card, the patient's password would be required. Thus, for the hospital to update the patient's medical history on the micro SD card, the hospital personal would request the password from the patient. If the patient forgets the password or is not capable of providing the password, the hospital can contact the patient's primary care physician would have the password on file and can provide the password to the hospital.

1. An emergency medical history display system capable of viewing a patient's medical history retained on a portable encrypted external memory device associated with a wearable device, where the medical history is viewable on a computer using a first pass code, the emergency medical history display system comprising:
a stand-alone view only computerized monitor configured to display a medical history of a patient, wherein the medical history resides on the portable encrypted external memory device;
an input port located on the monitor and being configured to receive the external memory device containing the patient's medical history; and
a processor, within the monitor, operable to:
allow the display, on the monitor, of the patient's medical history from the encrypted external memory device using a second as code wherein the first pass code is different from the second passcode and the second pass code is factory installed within the monitor;
when the external memory device is removed from the input port, immediately remove from the monitor all of the patient's medical history so that the patient's medical history is no longer viewable on the monitor; and
prohibit retaining in the monitor any of the patient's medical history stored on the external memory device when the external memory device is removed from the input port.

2. The emergency medical history display system of claim 1, wherein the monitor is sealed to prevent access to inside subcomponents of the monitor without breaking the casing of the monitor.

3. (canceled)

4. The emergency medical history display system of claim 1, wherein the input port is a USB port.

5. (canceled)

6. The emergency medical history display system of claim 1, further comprise
ng the portable encrypted external memory device, wherein the portable encrypted external memory device comprises a micro secure digital (SD) card.

7.-12. (canceled)

13. A method for viewing a patient's medical history during an emergency comprising the steps of:
storing a patient's medical history on a portable encrypted external memory device carried by the patient, the patient's medical history viewable using a first passcode on a computer;
displaying, by a stand-alone view only computerized monitor, the patient's medical history using a secord passcode wherein the first passcode is different from the second passcode and the second passcode is factory installed within the monitor, when the memory device is inserted in the monitor; and
immediately removing, by the monitor, the patient's medical history from the monitor when the memory device is removed from the monitor such that there is no retention of the patient's medical history in the monitor and the patient's medical, history is no longer viewable on the monitor.

14. (canceled)

15. The method of claim 13, further comprising storing the memory device in a wearable device with a water proof cover configured to protect the memory device.

16. The emergency medical history display system of claim 6, further comprising a wearable device with a water proof cover configured to hold the external memory device.

17. The emergency medical history display system of claim 6, wherein the external memory device is stored to where it is not visible when the wearable device is worn.

18. A system, comprising:
a portable encrypted external memory device configured to store encrypted medical data, the encrypted medical data being accessed using a first passcode;
a wearable device configured with a compartment into which the external memory device is stored;
a water proof cover configured to cover the compartment of the wearable device;
a computing device configured to access the encrypted medial data on the external memory device when the memory device is connected to the computing device, wherein the computing device displays the encrypted medical data using a second passcode wherein the first passcode is different from the second passcode and the second passcode is factory installed within the computing device; and the accessed encrypted medical data is automatically removed immediately from the computing device when the external memory device is removed from the computing device such that there is no retention of the encrypted medical data in the computing device and the accessed encrypted medical data is no longer viewable on the computing device.

19. The system of claim 18, wherein the computing device comprises a touch screen that can display the medical history of a patient when the external memory device is connected to the computing device.

20. The system of claim 18, wherein the computing device comprises an input port to receive the external memory device.

21. The system of claim 18, wherein the computing device being configured to detect if the external memory device is authorized to be accessed with computing device.

22. (canceled)

23. The system of claim 18, wherein computing device is a stand-alone view only computerized monitor comprising only one input port configured to receive the external memory device.

24. The system of claim 23, wherein the stand-alone view only computerized monitor is configured to prohibit retaining in the monitor any of the encrypted medical data stored on the external memory device when the external memory device is removed from the input port.

25. The system of claim 23, wherein the external memory device is configured to only allow stand-alone view only computerized monitors to exchanged data using the factory installed second pass code.

26. The emergency medical history display system of claim 1, wherein the external memory device is configured to only allow stand-alone view only computerized monitors to exchanged data using the factory installed second pass code.
